(19) United States
(12) Patent Application Publication
(10) Pub. No.: US 2021/0200614 A1
(43) Pub. Date: Jul. 1, 2021

(54) OPERATION SEQUENCE GENERATION APPARATUS, OPERATION SEQUENCE GENERATION METHOD AND PROGRAM

(71) Applicant: Nippon Telegraph and Telephone Corporation, Tokyo (JP)

(72) Inventors: Akio WATANABE, Tokyo (JP); Hiroki IKEUCHI, Tokyo (JP)

(21) Appl. No.: 17/265,878

(22) PCT Filed: Jul. 18, 2019
(86) PCT No.: PCT/JP2019/028331

§ 371 Date: Feb. 4, 2021

(30) Foreign Application Priority Data
Aug. 7, 2018 (JP) 2018-148198

(51) Int. Cl. G06F 11/07; G06N 3/08; G06N 5/04

(52) U.S. Cl. CPC G06F 11/079; G06N 5/04; G06N 3/08; G06F 11/0778

(57) ABSTRACT

An operation sequence generating apparatus of the present invention includes: a learning unit configured to learn a relationship between information indicating states of a computer system and word strings indicating the content of operations performed on the computer system in the states; and a generation unit configured to, upon receiving information indicating a new state of the computer system, generate a word string for the new state by inputting the received information to the relationship. This therefore mitigates the operation burden required for operation of the computer system.

### TECHNICAL FIELD

The present invention relates to an operation sequence generating apparatus, an operation sequence generating method, and a program.

### BACKGROUND ART

IT systems (computer systems) have become increasingly large-scale and include a greater diversity of equipment, and thus encounter an increasing number of failures, and it has become difficult to maintain high-quality management when failure recovery measures are performed by an operator as in conventional technology.

Automatic recovery systems have been developed in order to address this issue. In general, in an automatic recovery system, a preset procedure (scenario) is executed when triggered by the occurrence of a specific alarm for example, thus realizing recovery without operations being performed by an operator. Accordingly, alarms serving as triggers and corresponding scenarios need to be created in advance in the automatic recovery system.

However, the labor of manually creating scenarios an obstacle to the implementation of automatic recovery systems. This is because scenario creation requires extensive knowledge related to system operation, and can only be performed by persons who are experienced with the maintenance and operation of the target system. Because a scenario is often made up of several tens of operations (commands etc.) scenario creation is a very high-cost business. Also, in automatic recovery systems, a countermeasure is executed only if a pre-defined trigger condition is met, and therefore unknown failures cannot be handled. Furthermore, as failures become more complicated, the alarms serving as triggers also become very complex. There may also be complicated conditions where manual trigger setting is difficult. This difficulty in the setting of scenarios and triggers is an issue in the implementation of an automatic recovery system.

The biggest cause for scenario creation being laborious is that it is difficult for the “operation” elements that make up a scenario to be defined in advance. As related technology for automatic scenario creation, a technique has been proposed in which simulated operations are repeatedly performed in a test environment, and the system automatically learns to determine which of various predefined operations are to be executed based on the system state (NFL 1). There has also been a proposal for a technique for learning a series of operation procedures that are to be performed in order based on a history of past recovery procedures (NFL 2).

### CITATION LIST

### Non Patent Literature

[NPL 1] Tatsuji Miyamoto, Keisuke Kuroki, Masanori Miyazawa, Michiaki Hayashi, “DNN wo Tekiyo shita NFV Shogai Gvomu Prosesu Kanri Moderu no Teian (DNN-assisted Business Process Management Model for NFV Closed-loop Operation)”, IEICE Conference, B-14-4, 2018.

[NPL 2] Michael L. Littman, Nishkam Ravi, Eitan Benson and Rich Howard, “An Instance-based State Representation for Network Repair”, In Proc. of AAAI'04, pp. 287-292, 2004.

### SUMMARY OF THE INVENTION

### Technical Problem

However, with the conventional technology in NPL 1, NPL 2, and the like, the operation elements that. make up the scenario need to be defined in advance. There can possibly be several hundreds of operations that actually need to be defined. Also, if a new service or piece of software is implemented, the number of operations that need to be defined also increases, and the operation list also needs to be updated periodically. This therefore results in the problem that the types of failures that can be recovered from automatically with conventional technology is limited to a range of failures that can be handled with only predetermined operations. Also, parameter details, such as which host name apparatus is to perform an operation and which ID is to be set, need to be handled manually, and it is difficult to perform automatic recovery for failures that require such operations.

The present invention was achieved in light of the foregoing problems, and an object of the present invention is to mitigate the operation burden required in the operation of a computer system.

### Means for Solving the Problem

In order to solve one or more of the foregoing problems, an operation sequence generating apparatus includes: a learning unit configured to learn a relationship between information indicating states of a computer system and word strings indicating content of operations performed on the computer system in the states; and a generation unit configured to, upon receiving information indicating a new state of the computer system, generate a word string for the new state by inputting the received information to the relationship.

### Effects of the Invention

It is possible to mitigate the operation burden required in the operation of a computer system.

### BRIEF DESCRIPTION OF DRAWINGS

FIG. 1 is a diagram showing an example of an operation sequence that is output in an embodiment of the present invention.

FIG. 2 is a diagram showing an example of a hardware configuration of an operation sequence generating apparatus 10 in the embodiment of the present invention.

FIG. 3 is a diagram showing an example of a function configuration of the operation sequence generating apparatus 10 in the embodiment of the present invention.

FIG. 4 is a diagram showing units used in a learning phase.

FIG. 5 is a flowchart for describing an example of a processing procedure executed by the operation sequence generating apparatus 10 in the learning phase.

FIG. 6 is a diagram showing units used in an operation sequence generating phase.

FIG. 7 is a flowchart for describing an example of a processing procedure executed by the operation sequence generating apparatus 10 in the operation sequence generating phase.

### DESCRIPTION OF EMBODIMENTS

Hereinafter, an embodiment of the present invention is described with reference to the drawings. In the present embodiment, learning data includes information (alarms etc.) that indicates the states of a computer system (hereinafter, simply called the “system”) such as an IT system when failures occurred in the past, and operation sequences indicated by sequences of character strings indicating the content of operations performed in order to recovery from the failures, the learning data is used to learn the relationship between system states and operation sequences, and then when a new abnormality occurs, a plausible operation sequence is output based on the system state and presented to an operator.

A key aspect of the present embodiment is that the operation sequence that is output in response to a new failure is defined as a pure (simple) character string, such as a character string directly input using a keyboard, not a sequence made up of pre-defined operations as in conventional techniques. Note that “new failure” refers to a failure that has occurred after learning, and is not necessarily limited to being an unknown failure.

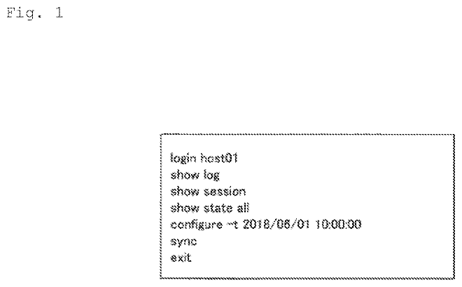

FIG. 1 is a diagram showing an example of an operation sequence that is output in this embodiment of the present invention. The operation sequence in FIG. 1 is a sequence of word strings such as “login, host01, <ENT>, show, log, <ENT>, show, session, <ENT>, show, state, all, <ENT>, configure, -t, 2018/06/01, 10:00:00, <ENT>, sync, <ENT>, exit, <ENT>, </s>”. Here, “word string” refers to a string of words separated by <ENT> or </s>. Note that “<ENT>” is a word corresponding to a line break that indicates a command execution, and “</s>” is a word indicating the end of a sentence. The output word candidates are all of the words in the history of operations included in the learning data.

If the operation sequence in FIG. 1 were to be output in conventional technology, the operations of each line would need to be manually defined in advance in an operation list, such as “login <host name>”, “show log”, and “show session”.

However, in the present embodiment, the words included in the learning data are directly used as output element candidates, and as long as there is a history of operations performed during past maintenance and operation, operations do not need to be manually defined in advance. Also, in conventional technology, an operation that includes a parameter, such as “login <host name>”, needs to be handled manually (in this case, “host01” is assigned). In contrast, in the present embodiment, if the word “host01” is included in the learning data, an operation that includes that parameter can also be estimated (more specifically, as will be described later, if the seq2seq Pointer mechanism is used, even if “host01” is not included in the learning data, an operation can be estimated as long as “host01” is included in input data).

Compared with a conventional method in which the input and the output are formulated and structured sequences, in the present embodiment in which the output is a sequence of word strings, the space of values that can be output is very large, and the relationship between input and output values is also complex. As one aspect for so living this technical problem, the following describes a technique that is based on one type of deep machine learning called a recurrent neural network, which can learn a complex relationship between input word strings and output word strings based on a large amount of learning data.

As will become apparent from the present embodiment, output operation sequences and a history of new operations performed by an operator can be added to the learning data in correspondence with an alarm string that indicates the system state that existed at the time. Accordingly, even if a new operation is added when the system is updated, the new operation can be learned automatically, and the list of operations does not need to be manually updated and managed, which is another advantage of the present embodiment.

The following is a more detailed description.

In the present embodiment, when some sort of information that indicates an abnormal system state (e.g., a CPU or HDD usage rate or a system alarm that is to be presented to the operator) is given as input, an operation sequence for returning the system state to normal output.

N sets of a system state and an operation sequence are given as learning data A (A={(Xᵢ, Yᵢ)}^{N}ᵢ₌₁). The output operation sequence is a simple sequence of word strings as described above. Yᵢ is the operation sequence of the i-th set in the learning data A, and is expressed as a sequence made up of Yᵢ=yᵢ₁yᵢ₂ . . . y_{1|Yi|} and yᵢₜ ∈v. Note that the word set V is the set of possible words, and is all of the words included in the operation sequences in the learning data. Also, |Yᵢ| is the total number of words included in the operation sequence Yᵢ.

Also, Xᵢ is the system state of the i-th set in the learning data A. Xᵢ is sequential data similar to an operation sequence in the case where a system alarm was issued for example, but in the case where a CPU usage rate or the like was input, Xᵢ can also be a vector that has does not have a time axis (e.g., non-sequential data), and therefore is not defined in terms of value. In other words, the value of Xᵢ is not limited to being a value in a predetermined format. For example, Xᵢ may include both sequential data and non-sequential data.

In conventional technology, a limited number of operations that can conceivably be output need to be defined in advance as an operation list. Accordingly, if the operation sequential data Yᵢ prepared for learning includes an operation that is not included in the operation list, the usage of Yᵢ as learning data needs to be abandoned (i.e., the inclusion thereof as a target for automation needs to be abandoned), or a new operation needs to be manually added to the operation list.

However, in the present embodiment, the word set V is mechanically expanded based on {Yᵢ}ᵢ, thus making it possible to reproduce character strings for practically all operations using combinations of words in the word set V. Accordingly, all of the data in the learning data can be included as targets for automation.

In the present embodiment, when a new system state X_{N+1} is given, an appropriate operation sequence Y_{N+1} that corresponds to X_{N+1} based on past learning data is output. This can be represented by the following expression.

Y_{N+1}=F(X_{N+1};A)

Note that the operation sequence Y_{N+1} is a simple character string. Accordingly, the function F can be said to be a function for converting the system state X_{N+1}, which includes sequential data or non-sequential data or includes both sequential data and non-sequential data, into a character string that indicates an operation sequence.

In the learning phase in the present embodiment, the parameters of the function F are calculated based on the learning data A. Specifically, letting Y′ᵢ be the output when Xᵢ is given to the function F, the parameters of the function F are calculated such that Yᵢ calculated as the answer for Xᵢ is as close to Y′ᵢ as possible. In the operation sequence generating phase, Y_{N+1} is output based on the input X_{N+1} and the function F that employs the calculated parameters.

Given that the length |Y| of the output Y is unknown, the function F needs to be able to output a variable-length sequence. A recurrent neural network (RNN) is a learning model that can learn a relationship between input and output and whose output can have any length. In the present embodiment as well, an RNN can be used to model the relationship between states X and operation sequences Y.

The following is an overview of an RNN. An RNN is constructed by a function f(X, sₜ₋₁) that outputs a hidden element sₜ when given an input value X and a value sₜ₋₁ called a hidden element at a certain time t, and a function g(sᵢₜ) that outputs a word included in V when sₜ is input, and the expression g(sᵢₜ)=g(f(Xᵢ, sᵢₜ₋₁)) repeatedly generates words and intermediate layers until </s> is output. Learning is performed until g(f(Xᵢ, sᵢₜ₋₁)) matches yᵢₜ of the learning data as closely as possible.

Note that the method for realizing the present embodiment is merely required to be a method that can output a variable-length sequence, and the present embodiment is riot limited to being realized using an RNN. For example, the relationship between states X and operation sequences Y may be modeled using a seq2seq (sequence-to-sequence) technique in which, if the input Xᵢ is a sequence that is similar to an operation sequence (e.g., data including a list of alarms that were issued), the input and output are both sequences (note that this is also one type of extension of an RNN). In particular, a seq2seq model with attention has been proposed as an improvement in precision in recent years, and this model introduces a variable indicating whether or not attention is to be given to elements in a string given as input, and the influence of this variable is also learned. A technique called a pointer mechanism has also been proposed, and with this mechanism, even if a word is not included in the learning data (a word is not included in Y), a word can be copied from the input value X_{N+1} and inserted into the output value Y_{N+1}. Incorporating these techniques is promising in terms of improving precision in the generation of correct operation sequences and handling variable parameters, such as in the case where an apparatus name that appears in an alarm in input data (a new apparatus name that does not appear in the learning data) is to be embedded as an argument parameter in a command in output data.

As another example, it is also conceivable to output an operation sequence when both sequential data and non-sequential data are given as input. This corresponds to a case of generating an operation sequence when given an alarm sequence and a corresponding system state (CPU usage rate, HDD usage rate, CPU temperature, etc.) as input. If the input is only an alarm, then even in the case of a failure event where it is difficult to uniquely specify an operation sequence, a higher-precision operation sequence can be expected to be output if appropriate non-sequential data is added as additional information. With seq2seq, many models that receive one sequence as input and output a different sequence have been proposed, but there have not been any proposals for a model that can handle the case where both sequential data and non-sequential data are received as input at the same time.

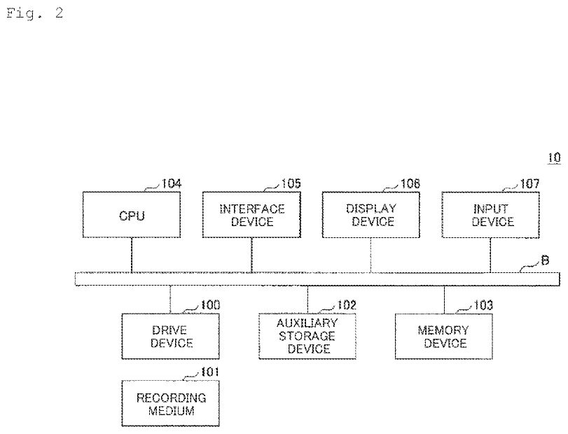

The following is a detailed description of an operation sequence generating apparatus 10 that realizes the content described above. FIG. 2 is a diagram showing an example of the hardware configuration of the operation sequence generating apparatus 10 in this embodiment of the present invention. In FIG. 2, the operation sequence generating apparatus 10 includes a drive device 100, an auxiliary storage device 102, a memory device 103, a CPU 104, an interface device 105, a display device 106, an input device 107, and the Like, all of which are connected to each other by a bus B.

A program that realizes processing in the operation sequence generating apparatus 10 is provided by a recording medium 101 such as a CD-ROM. The recording medium 101 that stores the program is set in the drive device 100 and installed from the recording medium 101 to the auxiliary storage device 102 via the drive device 100. However, the program is not necessarily required to be installed from the recording medium 101, and may be downloaded from another computer via a network. The auxiliary storage device 102 stores the installed program, as well as necessary files, data, and the like.

When a program startup instruction is received, the memory device 103 reads out the program from the auxiliary storage device 102 and stores the program. The CPU 104 realizes functions pertaining to the operation sequence generating apparatus 10 in accordance with the program stored in the memory device 103. The interface device 105 is used as an interface for connections to the network. The display device 106 displays a GUI (Graphical User Interface) and the like in accordance with the program. The input device 107 is constituted by a keyboard and a mouse or the like, and is used for the input of various operation instructions.

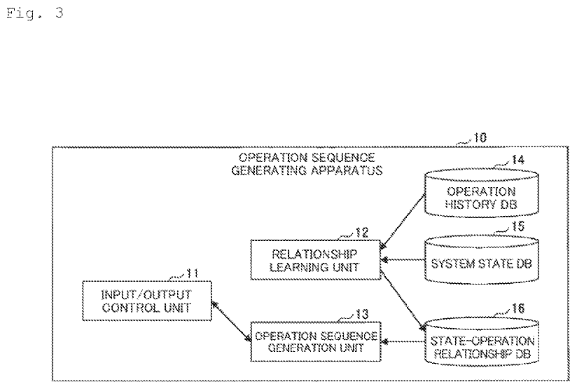

FIG. 3 is a diagram showing an example of the function configuration of the operation sequence generating apparatus 10 in this embodiment of the present invention. In FIG. 3, the operation sequence generating apparatus 10 has an input/output control unit 11, a relationship learning unit 12, an operation sequence generation unit 13, and the like. These units are realized by processing when the CPU 104 executes one or more programs installed in the operation sequence generating apparatus 10. The operation sequence generating apparatus 10 uses databases (storage units) such as an operation history DB 14, a system state DB 15, and a state-operation sequence relationship DB 16. These databases (storage units) can be realized using, for example, storage devices that can be connected to the auxiliary storage device 102 or the operation sequence generating apparatus 10 via the network.

The input/output control unit 11 performs control regarding input from a user and output to a user, for example. The system state DB 15 accumulates (stores) information that indicates a corresponding system state for each of past system failures. The operation history DB 14 accumulates (stores) operation sequences that indicate sequences of word strings that indicate the content of operations performed for the system states indicated by the information stored in the system state DB 15. The relationship learning unit 12 learns a relationship between the system states and operation. sequences, which are character strings (word string sequences) that indicate the content of operations performed for recovery from the corresponding system states. Information indicating the relationship learned by the relationship learning unit 12 (i.e., the parameters of the function F) is stored in the state-operation sequence relationship DB 16. Upon receiving information indicating a new system state, the operation sequence generation unit 13 inputs the system state to the relationship indicated by the information stored in the state-operation sequence relationship DB 16, and generates an operation sequence for that system state.

The processing executed by the operation sequence generating apparatus 10 includes a learning phase in which the relationship between system states and operation sequences is learned in advance and stored as a learning result (relationship), and an operation sequence generating phase in which an operation sequence is generated for a new system state (indicating an abnormality) based on the relationship that was stored in the learning phase.

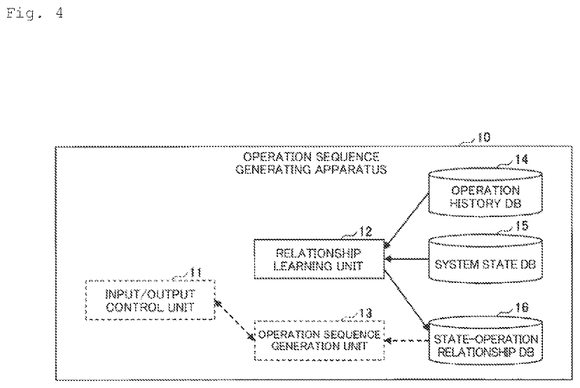

FIG. 4 is a diagram showing units used in the learning phase. In FIG. 4, the units used in the learning phase are shown using solid lines, and the other units are shown using dashed lines. Here, the relationship learning unit 12, the operation history DB 14, the system state DB 15, and the state-operation sequence relationship DB 16 are used in the learning phase.

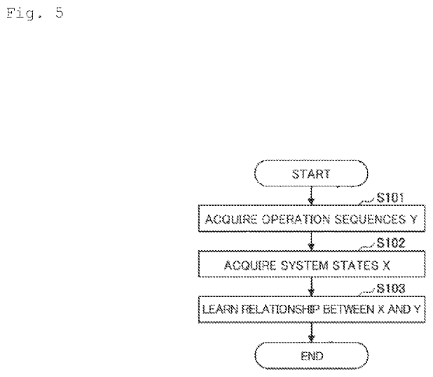

FIG. 5 is a flowchart for describing an example of a processing procedure executed by the operation sequence generating apparatus 10 in the learning phase.

In step S101, the relationship learning unit 12 acquires operation sequences Y={Y₁, Y₂, . . . , Y_{N}} from the operation history DB 14. The operation history DB 14 stores a word string for each operation sequence (a string of words obtained by dividing the operation sequence into words). Note that IDs assigned to words (hereinafter called “word IDs”) may be stored instead of the words themselves. In this case, the Yᵢ is a word ID sequence as shown below, for example.

### Yᵢ=(4, 8, 2, 6, 7, 2, . . . , 5, 2, 3)

Word IDs and words are associated in pairs in a “dictionary” as shown below, for example. This operation sequence Yᵢ is shown in FIG. 1. The dictionary may be generated from the words that appear in all of the data pieces Y₁Y₂, . . . , Y_{N} and stored in the operation history DB 14, for example.

Dictionary={1:ssh, 2:<ENT>, 3:</s>, 4:login, 5:exit, 6:show, 7:log, 8:host01, . . . }

Next, the relationship learning unit 12 acquires states X={X₁, X₂, . . . , X_{N}} from the system state DB 15 (S102). Here, Xᵢ is a set of non-sequential data A and sequential data B as shown below, for example. Note that Xᵢ may be only non-sequential data or only sequential data.

### Xᵢ[A, B]

In this example, the non-sequential data is A=(0.3, 0.7, . . . , 42), which is a numerical vector representation of “CPU usage rate 30%, HDD usage rate 70%, . . . , CPU temperature 42° C.”. Also, in this example, the sequential data is B=(1, 4, 13, 22, 5, . . . , 3), which is a vector of alarm IDs in order of issuance.

Next, the relationship learning unit 12 learns the relationship between the states X and the operation sequences Y as the values of parameters of a model that indicates the relationship (function F), and stores the learning result (the values of the parameters) in the state-operation sequence relationship DB 16 (S103). For example, the relationship learning unit 12 models the relationship using an RNA or seq2seq.

For example, in the case of modeling the relationship using seq2seq, the function F is constituted by a neural network, and therefore the values of weight parameters in the neural network are stored in the state-operation sequence relationship DB 16. For example, letting the weight parameters be Uⱼ, Wⱼ, and bⱼ, the following weight parameter values are stored in the state--operation sequence relationship DB 16.

U₁=0.3, U₂=0.5, . . .
W₁=0.2, W₂=−0.7, . . .
b₁=−0.4, b₂=0.0, . . .
Note that if a word not registered in the dictionary is included in the operation sequence Yᵢ when learning the relationship between the states X and the operation sequences Y, the relationship learning unit 12 registers that word and a word ID for that word in the dictionary. The word ID may be automatically generated by the relationship learning unit 12, for example.

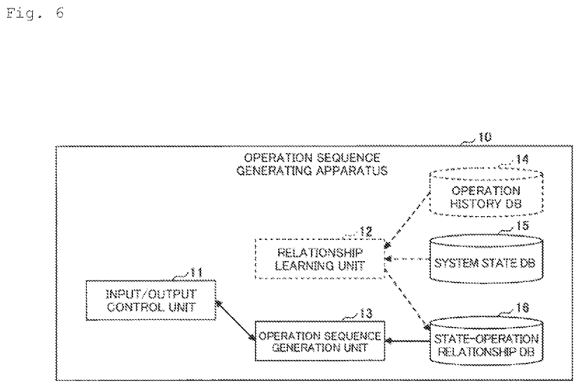

FIG. 6 is a diagram showing units used in the operation sequence Generating phase. In FIG. 6, the units used in the operation sequence generating phase are shown using solid lines, and the other units are shown using dashed lines. Here, the input/output control unit 11, the operation sequence generation unit 13, and the state-operation sequence relationship DB 16 are used in the operation sequence generating phase.

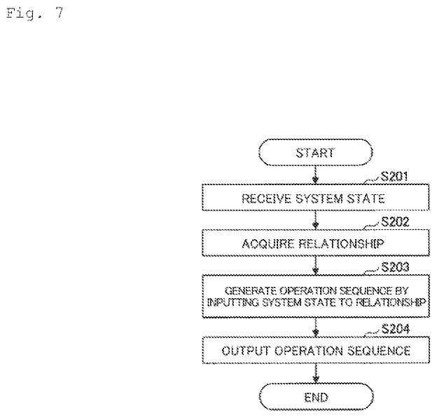

FIG. 7 is a flowchart for describing an example of a processing procedure executed by the operation sequence generating apparatus 10 in the operation sequence generating phase.

In step S201, the input/output control unit 11 receives a new system state X_{N+1}. Next, the operation sequence generation unit 13 acquires the values of the parameters of the function F, which indicates the relationship between the states X and the operation sequences Y, from the state-operation sequence relationship DB 16 (S202). Next, the operation sequence generation unit 13 generates the operation sequence X_{N+1} by inputting the state X_{N+1} to the function F to which the acquired values were applied (S203). Next, the input/output control unit 11 outputs the operation sequence X_{N+1} (S204). For example, the operation sequence X_{N+1} may be displayed by the display device 106.

Next, in order to give a detailed description of effects of the present embodiment, consider the following situation. A new service is started, and after operation for a certain period of time, approximately 1000 types of new operations patterns such as “commandX -q system” and “commandY -kv service” are included in the operation history. Consider the case of implementing an automatic recovery mechanism in this situation.

When attempting automatic recovery with conventional technology, the operation list needs to be defined in advance based on the operation history. It is very laborious to check the operation history and comprehensively define unfamiliar commands such as “commandX” and “commandY” along with their options such as “-q” and “-kv”, and this also requires highly technical knowledge. It actually ends up that only frequent command patterns are defined as operations, and complete automatic recovery is difficult.

However, with the present embodiment, data indicating past system states is registered in the system state DB 15, operation sequences that correspond to the system states are registered in the operation history DE 14, and the relationship between the system states and the operation sequences is learned. At this time, the new words “commandX”, “commandY”, “-g”, and “-kv” are also registered in the dictionary without fail, and combinations of commands and options are learned for various situations, and therefore approximately 1000 new operation patterns can substantially be modeled automatically. Accordingly, it is possible to automatically recovery from all sorts of failures that virtually appear in the learning data.

As described above, according to the present embodiment, if there is a large amount of data indicating system states in system failures that have occurred in the past and operation sequences indicating a history of operations taken by an operator co recover from such failures, it is possible to automatically generate an automatic handling procedure when a new system failure occurs. Here, the operation sequence are understood to be a word string including words included in operations, and the word string operation sequence is generated using a technique capable of generating variable-length sequences, such as a recurrent neural network. This therefore eliminates the need for scenarios and scenario execution triggers to be defined in advance, which has conventionally been costly, and makes it possible to generate an operation sequence using a combination of words obtained based on past operation sequences, and perform automatic recovery system. This therefore makes it possible to mitigate the operation burden of system operation.

Note that in the present embodiment, the relationship learning unit 12 is an example of a learning unit. The operation sequence generation unit 13 is an example of a generation unit.

Although the present invention has been described in detail using the above embodiment, the present invention is not intended to be limited to this specific embodiment, and various changes and modifications can be made within the scope of the gist of the present invention as recited in the claims.

### REFERENCE SIGNS LIST

10 Operation sequence generating apparatus
11 Input/output control unit
12 Relationship learning unit
13 Operation sequence generation unit
14 Operation history DB
15 System state DB
16 State-operation sequence relationship DB
100 Drive device
101 Recording medium
102 Auxiliary storage device
103 Memory device
104 CPU
105 Interface device
106 Display device
107 Input device
B Bus

1. An operation sequence generating apparatus comprising:
a learning unit, including one or more processors, configured to learn a relationship between information indicating states of a computer system and word strings indicating content of operations performed on the computer system in the states; and
a generation unit, including one or more processors, configured to, upon receiving information indicating a new state of the computer system, generate a word string for the new state by inputting the received information to the relationship.

2. The operation sequence generating apparatus according to claim 1, wherein the information indicating states of the computer system includes both sequential data and non-sequential data.

3. The operation sequence generating apparatus according to claim 1, wherein the relationship is modeled using a recurrent neural network.

4. The operation sequence generating apparatus according to claim 1, wherein the relationship is modeled using sequence-to-sequence.

5. An operation sequence generating method comprising:
a learning step of learning a relationship between information indicating states of a computer system and word strings indicating content of operations performed on the computer system in the states; and
a generating step of, upon receiving information indicating a new state of the computer system, generating a word string for the new state by inputting the received information to the relationship.

6. A non-transitory computer readable medium storing one or more instructions causing a computer to execute:
a learning step of learning a relationship between information indicating states of a computer system and word strings indicating content of operations performed on the computer system in the states; and
a generating step of, upon receiving information indicating a new state of the computer system, generating a word string for the new state by inputting the received information to the relationship.

7. The operation sequence generating method according to claim 5, wherein the information indicating states of the computer system includes both sequential data and non-sequential data.

8. The operation sequence generating method according to claim 5, wherein the relationship is modeled using a recurrent neural network.

9. The operation sequence generating method according to claim 5, wherein the relationship is modeled using sequence-to-sequence.

10. The non-transitory computer readable medium according to claim 6, wherein the information indicating states of the computer system includes both sequential data and non-sequential data.

11. The non-transitory computer readable medium according to claim 6, wherein the relationship is modeled using a recurrent neural network.

12. The non-transitory computer readable medium according to claim 6, wherein the relationship is modeled using sequence-to-sequence.
